(19) United States
(12) Patent Application Publication
(10) Pub. No.: US 2003/0065078 A1
(43) Pub. Date: Apr. 3, 2003

(54) Nylon multi-polymer solutions with improved shelf life

(76) Inventor: Rolando Umali Pagilagan, Parkersburg, WV (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/099,165

(22) Filed: Mar. 13, 2002

Related U.S. Application Data
(60) Provisional application No. 60/275,929, filed on Mar. 14, 2001.

(51) Int. Cl. C08K 3/10; C08K 3/00

(52) U.S. Cl. 524/436; 524/606

(57) ABSTRACT

Novel nylon multi-polymer solutions are disclosed having improved shelf-life and resistance to gelation. These solutions include a range of alcohols and nylon multi-polymers in combination with effective amounts of halide salts selected from Group IIA, Li, Zn, or Al. The solutions may be applied to a variety of substrates.

### CROSS-REFERENCE TO RELATED APPLICATION

This application claims the benefit of U.S. Provisional Application No. 60/275,929, filed Mar. 14, 2001.

### FIELD OF THE INVENTION

This invention relates to nylon multi-polymer solutions with improved shelf life. More specifically this invention relates to the use of multi-valent salts of Group IIA, Li, Zn, and Al to improve the stability of solutions of nylon multi-polymers.

### BACKGROUND OF THE INVENTION

Nylon “multi-polymers” are nylons made from a mixture of nylon forming monomers such that the nylon polymer contains a mixture of at least two types of nylon structural units. These types of nylons are sold commercially for coatings and adhesive applications. See for example brochures entitled “ELVAMIDE® Nylon Multipolymer Resins, Properties and Uses” (September 1977 and “ELVAMIDE® Nylon Multipolymer Resins for Thread Bonding” (October 1977), both published by E.I. DuPont de Nemours and Company, Inc.

An example of a commercially available multi-polymer is a terpolymer of nylon 6/66/610. Generally these nylons are readily soluble in organic solvents, especially alcohols, and are generally applied as solutions. The nylon coating is typically applied by dipping thread through a solution of the nylon multi-polymer and then subsequently passing the thread through a drying chamber and then to a fusing chamber generally at a temperature above the melting point of the nylon mixed polymer. Melting of the nylon multi-polymer coating on the thread promotes adhesion. Nylon mixed polymers are generally favored for this use because of their toughness, good abrasion resistance, and ready solubility in alcohols, as described in the brochures mentioned above.

Solutions of these nylon multi-polymers on standing will turn cloudy and eventually solidify. This phenomenon is called “gelation”. More information on gelation is provided in a variety of sources. See for example a third brochure from E.I. DuPont de Nemours and Company, Inc. entitled “ELVAMIDE® Product and Properties Guide” (December 1990) and Kohan, M. I., “Nylon Plastics Handbook” Hansen/Gardner Publications, Inc. (1995) pages 283-290. The shelf life of the nylon multi-polymer coating solution is very important in the coating process as it affects process flexibility and cost in a manufacturing plant. The time of gelation is influenced by many factors such as the composition of the nylon, temperature of storage, solvent, and concentration. The solution stability or shelf life can be improved by addition of water, benzyl alcohol, furfuryl acohol, m-cresol, or chlorinated hydrocarbons; see the ELVAMIDE® (September 1977 and December 1990) brochures mentioned above.

There are several constraints associated with currently available approaches to nylon multi-polymer solutions. For example, many such approaches rely on very high boiling solvents to improve the solution stability of the nylon multi-polymers. These higher boiling solvents, however, are expensive and harder to handle for a variety of reasons such as toxicity in the case of m-cresol and/or environmental emission during the coating process. The emission problem is particularly serious when using chlorinated hydrocarbons for example.

There is a longstanding need for nylon multi-polymer solutions that are less susceptible to gelation and that have improved shelf life. Improvements in these characteristics will allow the user to better manage the consumption and inventory of the solutions, and with attendant economic benefits as well.

An object of the instant invention is to provide nylon multi-polymer solutions having an extended shelf life before the onset of gelation, as compared to conventional approaches. A further object of the instant invention is to provide such solutions that can be effectively handled without producing deleterious emissions. A feature of the instant invention is its versatility, as it can be applied to a wide range of products. An advantage of the present invention is that these solutions may incorporate any of a variety of solvents including water. These and other objects, features and advantages of the invention will become better understood upon having reference to the following description of the invention.

### SUMMARY OF THE INVENTION

There are disclosed and claimed herein solutions of nylon multi-polymer comprising:

a) 55 to 99 weight percent alcohol selected from the group consisting of methanol, ethanol, 1-propanol, 2-propanol, 1-butanol or mixtures thereof,

b) 1 to 45 weight percent nylon multi-polymer derived from lactams containing 6-12 carbon atoms and polyamides derived from 4-12 carbon diamines or polyalkylene diamines and 4-12 carbon diacids, and

c) 0.2 to 10 weight percent based on the total weight percent of (a) and (b) of a halide salt selected from the group consisting of salts of Group IIA, Li, Zn, or Al with the requirement that the solubility of the salt in the solvent be at least 0.2 weight percent.

### DETAILED DESCRIPTION OF THE INVENTION

This invention relates to improving the shelf life or stability of nylon multi-polymer solutions by incorporating salts of Group IIA metals, Li, Zn, and Al. The use of these metal salts circumvents the problem of emission as these are non-volatile. Furthermore, these metals salts are used in much lower quantities than the higher boiling solvents and are generally much lower in cost. These metal salts can be used also in combination with these higher boiling solvents allowing a reduction in the amount of higher boiling solvents needed to attain a specific level of solution stability.

Preferred ranges for the solutions of the present invention are as follows, expressed as weight percent for the components designated by letters immediately above:

| | Preferred | More Preferred | Most Preferred |
|---|---|---|---|
| (a) | 70-97 | 80-97 | 85-97 |
| (b) | 3-30 | 3-20 | 3-15 |

Further, of the alcohols (a), methanol, ethanol, 1-propanol, and 2-propanol or their mixtures are particularly attractive. Suitable diamines for (b) include those from polyethylene glycol and polypropylene glycol. The halide salt is preferably used in an amount of 0.2-3 weight percent (based upon the total weight percent of (a) and (b)) in conjunction with any of the ranges of (a) and (b) preferred or otherwise as above. Moreover, the solutions disclosed herein may additionally contain up to 35 weight percent (and preferably up to 25 weight percent) of benzyl alcohol, phenol , m-cresol, furfuryl alcohol, chlorinated hydrocarbon, water, or mixtures thereof. This additional ingredient in the ranges quoted may be used in conjunction with any of the ranges of (a) and (b) preferred or otherwise as above. Water, benzyl alcohol, and mixtures thereof are of particular interest.

It is readily appreciated by those having skill in the art that the instant solutions are suitable for a wide range of applications and uses. For example, the solutions may be applied to mono-filaments and multi-filaments such as sewing threads. They may also be applied to films, fabrics, tubings, or injection molded parts. Essentially any structure for which such coatings and solutions are desirable are in fact suitable for treatment.

The invention will become better understood upon having reference to the following examples.

### EXAMPLE 1

A 15.0 weight percent solution of Elvamide® 8061, a 6/66/610 multi-polymer available from E.I. DuPont de Nemours and Company, Inc. was prepared by heating to almost boiling a mixture of 45.0 grams Elvamide® 8061 and 255.0 grams of methanol in a flask fitted with a condenser and magnetic stirrer. The solution was cooled to room temperature. The solution was then divided into 50.0-gram portions. To each of the 50-gram portions were added quantities of calcium chloride dihydrate as shown in Table I. The solutions were then observed for signs of clouding.

Clouding is indicative of gelation, and an assessment of clouding is made by close visual inspection of the sample. At any point during the observation and inspection that the solution developed a “haziness”, the data for “days to cloud” was recorded. Thus, by this criterion it is not necessary that the solution appear “opaque” or even “translucent”; instead and because the interest is in determining when the solution began to gel, the reading was completed as soon as the aforementioned haziness was apparent.

TABLE 1

| | | | WT. % | |
|---|---|---|---|---|
| | | | CALCIUM | |
| | | WT. % | CHLORIDE | DAYS |
| EX- | WT. % | ELVAMIDE ® | DIHYDRATE | TO |
| AMPLE | METHANOL | 8061 | (*) | CLOUD |
| Comp. | 85.0 | 15.0 | 0.0 | 3 |
| Ex. 1-1 | | | | |
| 1-2 | 85.0 | 15.0 | 1.0 | 3 |
| 1-3 | 85.0 | 15.0 | 2.0 | >40 |
| 1-4 | 85.0 | 15.0 | 4.0 | >40 |
| 1-5 | 85.0 | 15.0 | 6.0 | >40 |
| 1-6 | 85.0 | 15.0 | 10.0 | >40 |

(*) Wt. % of solution weight.

This demonstrates the dramatic improvement in solution stability by addition of at least 2 weight percent calcium chloride dihydrate resulting in over 40 days shelf life.

### EXAMPLE 2

A 15.0 weight percent solution of Elvamide® 8061 was made as in Example 1 using a mixture of methanol/water. Fifty-gram portions of the solution were taken and treated with different levels of calcium chloride dihydrate. The results are shown in Table 2.

TABLE 2

| | | | | WT. % | |
|---|---|---|---|---|---|
| | | | | CALCIUM | |
| | | | WT. % | CHLORIDE | DAYS |
| | WT. % | WT. % | ELVAMIDE ® | DIHYDRATE | TO |
| EXAMPLE | METHANOL | WATER | 8061 | (*) | CLOUD |
| Comp. | 79.0 | 6.0 | 15.0 | 0 | 3 |
| Ex. 2-1 | | | | | |
| 2-2 | 79.0 | 6.0 | 15.0 | 1.0 | 15 |
| 2-3 | 79.0 | 6.0 | 15.0 | 2.0 | >32 |
| 2-4 | 79.0 | 6.0 | 15.0 | 4.0 | >32 |
| 2-5 | 79.0 | 6.0 | 15.0 | 6.0 | >32 |
| 2-6 | 79.0 | 6.0 | 15.0 | 10.0 | >32 |

(*) Wt. % of solution weight.

The presence of water makes the calcium chloride more effective. The presence of 1.0 weight percent calcium chloride dihydrate increased the time to clouding to 15 days. In Table 1 with pure methanol solvent, 1.0 weight percent (Sample 1-2) level was not effective.

### EXAMPLE 3

A 15.0 weight percent solution of Elvamide® 8061 was prepared as in Example 1. Fifty-gram portions of the solution were taken and 2.5 grams of benzyl alcohol were added to each portion. Then to each of the portions were added different levels of calcium chloride dihydrate.

TABLE 3

| | | | | WT. % | |
|---|---|---|---|---|---|
| | | | | CALCIUM | |
| | | WT. % | WT. % | CHLORIDE | DAYS |
| EX- | WT. % | BENZYL | ELVAMIDE ® | DIHYDRATE | TO |
| AMPLE | METHANOL | ALCOHOL | 8061 | (*) | CLOUD |
| Comp. | 81.0 | 4.7 | 14.3 | 0.0 | 2 |
| Ex. 3-1 | | | | | |
| 3-2 | 81.0 | 4.7 | 14.3 | 0.1 | 3 |
| 3-3 | 81.0 | 4.7 | 14.3 | 0.2 | 6 |
| 3-4 | 81.0 | 4.7 | 14.3 | 0.3 | 13 |

(*) Wt. % of solution weight.

The addition of benzyl alcohol enhances the effect of calcium chloride. Even at 0.3 weight percent level the cloud point was extended to 13 days.

### EXAMPLE 4

An 11.0 weight percent solution of Elvamide® 8061 was prepared as in Example 3. To 50-gram portions of the solution was added benzyl alcohol and calcium chloride dihydrate. Results are shown in Table 4.

TABLE 4

| | | | | WT. % | |
|---|---|---|---|---|---|
| | | | | CALCIUM | |
| | | WT. % | WT. % | CHLORIDE | DAYS |
| EX- | WT. % | BENZYL | ELVAMIDE ® | DIHYDRATE | TO |
| AMPLE | METHANOL | ALCOHOL | 8061 | (*) | CLOUD |
| Comp. | 84.8 | 4.7 | 10.5 | 0.0 | 12 |
| Ex. 4-1 | | | | | |
| 4-2 | 84.8 | 4.7 | 10.5 | 0.4 | >31 |
| 4-3 | 84.8 | 4.7 | 10.5 | 0.6 | >31 |

(*) Wt. % of solution weight.

These results show the effect of nylon concentration on the time to clouding. Again the calcium chloride dihydrate affords improved shelf life compared to solution without the calcium chloride.

### EXAMPLE 5

A 15.0 weight percent Elvamide® 8061 was prepared as in Example 1. To 50-gram portions of the solution were taken and lithium chloride was added. Results are shown in Table 5.

TABLE 5

| | | | WT. % | |
|---|---|---|---|---|
| | | WT. % | LITHIUM | DAYS |
| EX- | WT. % | ELVAMIDE ® | CHLORIDE | TO |
| AMPLE | METHANOL | 8061 | (*) | CLOUD |
| Comp. | 85.0 | 15.0 | 0.0 | 1 |
| Ex. 5-1 | | | | |
| 5-2 | 85.0 | 15.0 | 1.0 | 7 |
| 5-3 | 85.0 | 15.0 | 2.0 | 15 |

(*) Wt. % of solution weight.

The results show that lithium chloride increases the shelf life of the solution but is not as effective as calcium chloride at the same level.

### EXAMPLE 6

A 15.0 weight percent solution of Elvamide® 8061 was prepared as in Example 1. To two fifty-gram portions of the solution were added benzyl alcohol to one and 1.8 weight percent aluminum chloride nonahydrate was added to the other. (equivalent to 1.0 weight percent anhydrous aluminum chloride)

TABLE 6

| | | | | WT. % | |
|---|---|---|---|---|---|
| | | | | ALUMIUNUM | |
| | WT. % | WT. % | WT. % | CHLORIDE | DAYS |
| EX- | METH- | BENZYL | ELVAMIDE ® | NONAHYDRATE | TO |
| AMPLE | ANOL | ALCOHOL | 8061 | (*) | CLOUD |
| Comp. | 81.0 | 4.7 | 14.3 | 0.0 | 3 |
| Ex. 6-1 | | | | | |
| 6-2 | 81.0 | 4.7 | 14.3 | 1.8 | 11 |

(*) Wt. % of solution weight.

This shows that aluminum chloride also improves solution stability but not as effectively as calcium chloride.

### EXAMPLE 7

A 15.0 weight percent solution of Elvamide® 8061 was made as in Example 1. Benzyl alcohol was added at two levels to 50-gram portions of the solution and calcium chloride dihydrate at 0.6 weight percent. Results are shown in Table 7.

TABLE 7

| | | | | WT. % | |
|---|---|---|---|---|---|
| | | | | CALCIUM | |
| | | WT. % | WT. % | CHLORIDE | DAYS |
| EX- | WT. % | BENZYL | ELVAMIDE ® | DIHYDRATE | TO |
| AMPLE | METHANOL | ALCOHOL | 8061 | (*) | CLOUD |
| Comp. | 81.0 | 4.7 | 14.3 | 0.0 | 5 |
| Ex. 7-1 | | | | | |
| Comp. | 77.3 | 9.1 | 13.6 | 0.0 | 12 |
| Ex. 7-2 | | | | | |
| 7-3 | 81.0 | 4.7 | 14.3 | 0.6 | 14 |
| 7-4 | 77.3 | 9.1 | 13.6 | 0.6 | >31 |

(*) Wt. % of solution weight.

Again these results show the additive effect of benzyl alcohol and calcium chloride on solution stability.

In the claims:

1. A solution of nylon multi-polymer comprising:
a) 55 to 99 weight percent alcohol selected from the group consisting of methanol, ethanol, 1-propanol, 2-propanol, 1-butanol or mixtures thereof,
b) 1 to 45 weight percent nylon multi-polymer derived from lactams containing 6-12 carbon atoms and polyamides derived from 4-12 carbon diamines or polyalkylene diamines and 4-12 carbon diacids, and
c) 0.2 to 10 weight percent based on the total weight percent of (a) and (b) of a halide salt selected from Group IIA, Li, Zn, or Al with the requirement that the solubility of the salt in the solvent be at least 0.2 weight percent.

2. The solution of claim 1 wherein said alcohol (a) is present in an amount of 70-97 weight percent and said nylon multi-polymer (b) is present in an amount of 3-30 weight percent.

3. The solution of claim 1 wherein said alcohol (a) is present in an amount of 80-97 weight percent and said nylon multi-polymer (b) is present in an amount of 3-20 weight percent.

4. The solution of claim 1 wherein said halide salt (c) is present in an amount of 0.2-3 weight percent based on the total weight of (a) and (b).

5. The solution of claim 1 further comprising up to 35 weight percent of benzyl alcohol, phenol, m-cresol, furfuryl alcohol, chlorinate hydrocarbon, water, or mixtures thereof.

6. The solution of claim 5 comprising water, benzyl alcohol, or mixtures thereof.

7. A structure coated with the solution of claim 1.

8. A structure of claim 7 selected from the group consisting of mono-filaments, multi-filaments, films, fabrics, tubings, and injection-molded parts.
